(19) United States
(12) Patent Application Publication
(10) Pub. No.: US 2008/0243588 A1
(43) Pub. Date: Oct. 2, 2008

(54) System and method for calculating new product first year net margin contribution

(75) Inventor: James Michael Connolly, Dover, MA (US)

Correspondence Address: WAREHOUSE PRODUCTS TESTING, INC., 20 MINUTEMAN WAY, BROCKTON, MA, 02301, US

(73) Assignee: WAREHOUSE PRODUCTS TESTING, INC., Brockton, MA (US)

(21) Appl. No.: 11/695,476

(22) Filed: Apr. 2, 2007

(51) Int. Cl. G06F 17/30

(52) U.S. Cl. 705/10

(57) ABSTRACT

A comprehensive computer implemented method provides the effect on contribution margin that results from substituting a test product for an incumbent product in the test product's peer group. The method normalizes test and control store data by applying subcategory indices to calculate margin lift and to forecast sales for selected store distribution. The method further determines the effect of new product build-rate on forecasted sales for test products in their first year of distribution. The method calculates a plurality of cost and income effects on contribution margin including net vendor funding, advertising and promotion effects, net markdowns, incumbent item disposition costs, and net plan-o-gram expense among others. The system provides a category manager with a single dollar metric that specifically identifies the economic effect of authorizing distribution for a test product in all or a subset of the retailer's stores.

### FIELD OF THE INVENTION

The present invention relates to determining the financial impact of introducing a new product into a retailer's product assortment. More particularly the invention relates to calculating the effect on a retailer's annual contribution margin that results from substituting a test product for an incumbent product in the test item's peer group.

### BACKGROUND OF THE INVENTION

Historically products have been introduced into retail stores for a variety of reasons. These reasons include being first to market with new products, refreshing the assortment, improving margins, and the collection of fees associated with granting new distribution to vendors, known as vendor funds.

As is well known in the industry the focus of retailers for many years was to generate the largest amount of vendor funding possible and to chum products through the distribution cycle in as little time as possible. Increasingly however financial analysts began to question the wisdom of clogging the supply chain with items that did not move, thereby impeding cash flow. The concept of opportunity cost was applied to shelf space which prior to that time was allocated to a large number of similar items.

Management consultants employed by the largest retailers developed the widely emulated strategies of Vendor Consolidation and SKU Rationalization. These strategies required fewer items from fewer vendors. For a period of time there was intense focus on eliminating items and vendors. With few exceptions only well funded new items from large vendors were introduced.

The strategies of Vendor Consolidation and SKU Rationalization were reinforced by a wave of mergers and acquisitions as retailing in every channel of distribution consolidated.

Recently the pendulum began to swing back as item cutting reached bone. A balance was sought between supply chain rigor and product assortments that attract and entice shoppers. Today “Tier 1” products with large budgets are readily accepted. Tier 2 and 3 products are not usually accepted without proof that they will succeed. Testing provides such proof. As is well known to those in retailing testing products for limited periods of time in a limited number of test stores is widely practiced.

Typically Category Mangers consider test results in terms of average units moved per store per week. A “hurdle rate” is established and a product is selected when the hurdle rate is exceeded and sufficient vendor funding is offered.

It is well known among retailers that the time horizon considered by Category Managers is almost universally one year. Calculations of a test product's annual volume are frequently made. Typically the average test store unit movement is multiplied by the number of stores in a chain and then by fifty-two weeks in a year to produce an annual unit volume forecast that is easily converted into an annual dollar sales forecast. Such superficial volume forecasts fail to consider important factors such as seasonality and first year volume build-rate as a product becomes increasingly known to shoppers.

Historically the selection of test stores is a process designed to identify a set of stores that are representative of the entire chain. Typically, test stores have been selected on the basis of the store's shopper demographics. The selection process is done either by store personnel or by organizations like the Spectra Group which is well known in the industry. This test store identification process frequently produces inaccurate forecasts because being representative in terms of shopper demographics does not ensure representative purchase patterns at the subcategory and peer group levels.

Similarly store employees or groups like Spectra match test stores and control stores on the basis of demographics. It can be readily demonstrated that test and control stores matched by demographics frequently have different purchase rates at the subcategory level.

The present invention indexes control stores to test stores and test stores to all stores based on prior year subcategory sales which produces much more accurate forecasts.

While attention is paid in sophisticated retailers to “category sales lift” and “cannibalization rate” both of these rates produce inaccurate forecasts without correct data normalization.

Most retailers are presently aware of an impact on profit when an incumbent product is replaced by a successfully tested new product. Some retailers have developed “Markdown Calculators” to determine the impact of marking down product in order to make room for a new product. None of these models address the issue of cannibalization by clearance items which is often financially significant.

Until now there has been no comprehensive analytical model that accurately normalizes test store and control store sales, accounts for first year build rate, seasonality, normalized margin lift, advertising effect, promotion effect, vendor funds, markdowns, cannibalization, incumbent product inventory disposition, and shelf work to cut in a new product. The present invention produces a single value equal to the increase or decrease in contribution margin that results when a new product is substituted for an existing product in its peer group.

This invention provides an accurate and time saving tool to assist Category Managers in making new product authorization decisions.

### SUMMARY OF THE INVENTION

The present invention provides a system and method that responds to the need of retail Category Managers to know what the impact on gross margin will be if they replace an incumbent item in their product assortment with a new product that has tested above a given hurdle rate.

The invention provides a comprehensive algorithm that is usable across a plurality of hardware platforms and software programs. Sales and other data is collected, sorted and selected usually by one or more of such software programs and is exported typically through an interface into Microsoft Excel, a widely used spreadsheet software program in which subsequent calculations are made.

Downloaded data comprises sales volume, retail pricing, and cost information pertinent to a test product's peer group constituents.

“Sales lift” and “margin lift” are determined by comparing the sales of test stores to control stores during the test period. Control stores are typically matched to test stores on the basis of shopper demographics. Margin lift is essential to the method of the present invention. In order to realize much greater accuracy than that provided by the customary practice of comparing test store and control store sales, the raw sales data of control stores is indexed to test store sales data in the present invention. The basis for the index number that is used is the comparative annual sales of test and control store groups at the subcategory level.

This analytical model provides additional information that is not critical to the method but is typically considered by Category Managers such as peer group sales rank, margin rank, and test product cannibalization.

The present invention forecasts the first year sales and gross margin of the test product. Although test stores are selected to be representative of the entire chain, much greater forecasting accuracy is achieved by indexing test-store sales to all-stores sales at the subcategory level. Software programs used by retailers typically aggregate sales data at the subcategory level and above.

In practice the selection of test stores tends not to be representative, more particularly over time. An ancillary benefit of indexing test store sales is that test stores can be selected from a much larger store pool. Similarly there is greater flexibility in selecting control stores although control store markets should correspond to the test store markets so that similar market forces affect both groups.

Test product sales in the test period provide baseline bimonthly data from which subsequent bimonthly sales are calculated using factors for both seasonality and bi-monthly first year growth. Seasonality is derived from sales history of the subcategory and first year growth rate is derived from the average growth rate of new items introduced within the category.

Other factors that affect test product sales and gross margin forecasts include advertising and promotion effect, test store index number, and an in-stock index that is provided by historical records for the subcategory.

A process identical to the calculations used to project test product sales and gross margin is used to calculate annual margin lift and annual sales lift.

Calculations are introduced that identify the effect of marking down product intended to be replaced by the test product. Included is a calculation of sales cannibalized by the clearance item.

Reclamation costs are determined that include both the effect of markdowns and the cost of collecting and disposing of remaining inventory not sold at markdown.

A series of calculations determine the net effect of vendor funds, reclamation costs, and shelf work to cut in the new product. The sum of these increases and decreases is added to the forecasted annual margin lift.

The result is THE NUMBER, which is the increase or decrease to a peer group's contribution margin that results when the test product is substituted for an item in its peer group.

THE NUMBER provides Category Managers with a mathematical model that substantiates their decision of whether or not to authorize a test product for distribution. In addition there is substantial time-savings that the present invention provides to Category Mangers and Assistant Category Managers.

### DETAILED DESCRIPTION OF THE INVENTION

In describing an embodiment of the invention specific terminology will be used for the sake of clarity. However the invention is not intended to be limited to these specific terms, and it is to be understood that each of the specific terms includes all equivalents which operate in a similar manner to accomplish a similar purpose.

The present invention is described in the context of a commercial embodiment referred to as THE NUMBER. The invention is implemented with any combination of hardware and software.

The present invention can be included in an article of manufacture (e.g. one or more computer program products) having for instance computer useable media. The media has embodied therein, for instance, computer readable program code means for providing and facilitating the mechanism of the present invention. The article could be used as part of a computer system or separately.

It will be appreciated by those skilled in the art that changes could be made to the embodiment described herein without departing from the broad inventive concept thereof. It is understood therefore that the invention is not limited to the particular embodiment disclosed but is intended to cover modifications within the spirit and scope of the invention.

The embodiment described herein is referred to as THE NUMBER. Attached hereto and identified as Table 1 is an embodiment of the present invention.

The test product in this embodiment is a saline nasal spray, specifically two separate SKUs NielMed Sinus Rinse Kit and NielMed Sinus Rinse Refill Packets. As is well known to those engaged in retailing a “product” is frequently comprised of a plurality of SKUs with different accidental properties as by way of example size and color, but with the same essential properties.

Since the data contained in this embodiment is proprietary, the retailer at which the test was conducted is referred to as the Test Retailer. In the present invention a test product populates in part a Peer Group which in turn populates in part a Subcategory which in turn populates in part a larger group known to retailers as a Category. In a particular embodiment the Category would comprise all cough and cold remedies. The Subcategory would comprise all nasal sprays whether medicated or not. The Peer Group would comprise all saline sprays which function as nasal irrigants or moisturizers.

It is an object of the present invention to calculate the increase or decrease in contribution margin that will result from substituting a test product for an incumbent product in its peer group. In the particular embodiment disclosed in Table 1 the incumbent products to be replaced comprise the bottom quartile for the Peer Group and specifically are AYR Saline Nasal Spray Gel and Fleming Ocean Nasal Mist (Table 1-A). It should be understood however that in a preferred embodiment the size of the Peer Group is indeterminate and the calculated volume of each item to be replaced is the average volume of the bottom quartile of the Peer Group constituents. It is well understood by retailers that there can be reasons why the lowest volume items in a peer group would not be replaced as by way of non-limiting example contractual obligations.

In Table 1-B the Bottom Quartile average retail price and average cost are identified. These values will be used later in the model when the Markdown effect is calculated. In the present embodiment these values are $4.70 and $2.50 respectively.

In Table 1-B product cost is deducted from Retail price resulting in gross margin per unit. The percentage gross margin is calculated by dividing margin per unit by the retail price. Sales dollars divided by sales price provides units sold. Units sold times margin per unit produces dollar margin for each item. Sales dollars and margin dollars are aggregated. The average Retail Price and Average Cost are weighted by volume.

In Table 1-C Peer Group Sales in Control Stores are ranked by volume. In this Table Control Store sales are converted to Indexed Control Sores by multiplying raw sales by an Index. The Control Store Index is calculated by dividing the running prior 12 month Sub-department sales in the Control stores by the running prior 12 month Sub-department sales in the Test Stores.

The present test was conducted in geographically dispersed Test Retailer stores. The term “Sub-department” which is used by the Test Retailer is equivalent to “Subcategory” sales at other retailers, as by way of non-limiting example, Rite Aid.

The software program used by the Test Retailer to generate sales data is “Micro Strategy”. The software program used to generate sales data at Rite Aid was developed in-house and is known as Catalyst Data 4.0. Both software programs aggregate data at the Subcategory level and above.

The Control Store Index number in the present embodiment is 1.04686. The raw Control Store sales value for each SKU in the Peer Group is divided by the Control Store Index resulting in Indexed Control Store dollar sales for each. Indexing control store data removes the bias between test and control store data recorded in the test period. Removing the bias makes it possible to accurately compute category lift and cannibalization rates.

In Table 1-D Indexed Dollar margin is created for Peer Group items in Control Stores. Indexed Control Store Dollar Sales are multiplied by the percentage gross margin indentified for each item in Table 1-B, resulting in Indexed Control Store Gross Margin for each item in the Peer Group. Control Store Indexed Gross Margin is ranked.

At the bottom of Table 1-D is a calculation of the cost of inventory for the Bottom Quartile Peer Group Items. The Bottom Quartile Peer Group Items are identified from the forced ranked margin shown in the top section of Table 1-D. As discussed above a particular peer group's bottom quartile can consist of more or less than 2 items which is dependent upon the size of the peer group.

The Bottom Quartile of the Peer Group is selected as the likely pool for items to be replaced. Bottom quartile constituents' sales and gross margins are aggregated and averaged for the test period. Both are divided by the number of stores in the test producing average bottom quartile sales per store for the bimonthly test period. The results are multiplied by the number of stores in the chain and again by the number of bi-monthly periods in a year (6) to produce the annual Peer Group Bottom Quartile sales and margin per item. Average annual margin is deducted from average annual sales to produce annual Bottom Quartile Peer Group cost of sales per item. This amount is divided by the number of inventory turns per year which yields the cost of inventory per peer group item in the bottom quartile. This result appears later in an analysis of reclamation costs. In the present embodiment the cost of inventory per item in the bottom quartile of the peer group is $7,018.

Table 1-E presents a forced ranking of the sales dollars of Peer Group items in the test stores. Unlike the Peer Group in the Control Stores the test store Peer Group includes the test item (2 SKUs in this embodiment). Although the ranking of a test products' peer group constituents is not essential to the calculation of THE NUMBER, it is of interest to Category Managers and factors into their decision on test items.

Table 1-F presents a forced ranking of the gross margin of Peer Group constituents in the test stores. The calculation method for gross margin in test stores is similar to that for control stores. It should be obvious to one skilled in the art that gross margin rankings do not necessarily correspond to sales rankings because the percentage gross margin by which sales dollars are multiplied can be markedly different. In the present embodiment gross margin percentage ranges from 78% to 39%.

In addition to margin rankings, Table 1-F also presents share of sales and share of margin percentages. These percentages, like rankings are extraneous to calculation of THE NUMBER but are considered by Category Managers in new product authorization decisions. The tables also allow Category Managers to compare test store data with indexed control store data and visualize the cannibalization effect of the test product on individual items in the peer group.

Table 1-G presents a calculation of sales lift and margin lift. The latter is the linchpin in determining the increase or decrease in contribution margin effectuated by the present invention.

Sales Dollar Lift is determined for each item in the peer group by subtracting Indexed Control Store Sales from Test Store Sales Dollars. The Peer Group Sales Dollar Lift that results in a test is determined by aggregating the dollar lift of all peer group items. It is obvious that test product sales in the control stores equal zero. An anomaly appeared in the present embodiment in that the sales of one other item in the peer group also equaled zero not only in the control stores but also in test stores. In the present embodiment Test period Sales Dollar Lift is $444.

Margin Lift for the Peer Group is calculated in the same manner as Sales Dollar Lift. It should be obvious to one skilled in the art that an option exists to remove two products from the test stores and replace them with the test products. It can be postulated that doing so would increase the sales of the test product. It can also be postulated that not doing so increases the potential sales and margin lift that results from the test. There is no empirical evidence available to support either of these postulates. In the present embodiment Test period Margin Lift is $338.

Test period Margin Lift is used later in the analysis in the calculation of annual peer group margin lift. Test period Sales Lift is used later in the analysis in the calculation of annual peer group sales lift. Both of these values impact the calculation of vendor funds lift that appears still later in the analysis.

Table 1-H identifies the amount of Cannibalization of both sales and margin dollars created by selling the test product (2 SKUs in this embodiment). Sales Cannibalization is calculated for each item in the Peer Group except the test products by subtracting Indexed Control Store Sales from Test Store Sales during the test period (8 weeks in this embodiment). To calculate Margin Cannibalization for each item in the Peer Group except the test product, Indexed Control Store Sales are first multiplied by the percentage gross margin and are then deducted from the product of test period sales in Test Stores times the percentage gross margin. To calculate the Peer Group Sales Cannibalization, the cannibalization amounts for individual items are aggregated for all items in the Peer Group excluding the test item sales which are segregated. Margin Cannibalization for the Peer Group is calculated in similar fashion. In the present embodiment Sales Cannibalization is −$120. Margin Cannibalization is +103 due to mix and the broad range of gross margin percentages.

Generally the aggregated Cannibalization value for the Peer Group is a negative number meaning that without the test product, sales of the test stores are usually less than the Indexed Control store sales. This is not always the case since there can be instances when an entire category's sales are lifted by the presence of a test item.

Not all individual Peer Group items experience negative cannibalization. Positive cannibalization at the item level is considered random. In rare instances a sales amount will be noticeably outside the data pattern. In such cases the analyst will look at transaction data to determine the cause if possible. When an anomaly exists, the week's sales volume of the item in question is deleted from the store where the anomaly is found and from its matching (test or control) store. The anomaly is footnoted, as by way of non-limiting example a school might purchase a year's supply of an item from a local drugstore during the test period.

Table 1-I identifies two distinct sales volumes of all stores in the retail chain. These sales volumes are 1.) “Front end” sales, and 2.) “Subclass” sales. More specifically, in this embodiment “front end” sales at the Test Retailer stores are further defined as “running 52 weeks”. “Front end” sales are drugstore sales that exclude pharmacy sales volume. “Running 52 weeks” refers to aggregate weekly sales beginning immediately prior to the test period and stretching back 52 weeks from that point (in the present embodiment from the fiscal week ending Feb. 3, 2005 back to the fiscal week ending Feb. 12, 2004).

The first volume total amount in this table is all front end sales volume in all stores (in this embodiment $34,937,236,812). This amount is divided by the average number of stores in the chain during the period (in this embodiment 2,242) resulting in the average annual front end sales volume per store (in this embodiment $15,583,067).

Running 52 week front end Subclass sales are aggregated similarly (not shown). In the present embodiment the total of running 52 week front end Subclass sales equals $2,889,244. Subclass units are also shown in this table but are not intrinsic to the analysis, although sometimes useful to Category Managers.

Finally Subclass sales per store are calculated by dividing running 52 week subclass sales by the average number of stores in the chain for the period (in this embodiment 2,242). In the present embodiment running 52 week Subclass Sales per store equal $1,289. This amount will be used in the following table.

Table 1J compares test store volume with all store volume and produces an Index number by which Test Store projections are later factored to remove the test store volume bias. It is well known to those engaged in retailing that in relatively small well executed tests the test stores are typically selected from a pool of stores that are above average in volume even when their demographic profiles may be considered representative of the chain as a whole. In larger tests (as by way of non-limiting example regional tests) the test store volumes are closer to average. Execution of logistics in larger tests is less controlled which produces significant test error and inaccurate data. It can be readily demonstrated that test error produced by execution below 75% significantly outweighs the statistical benefit of larger sample size. Test execution below 75% is typical in large retail store tests.

In this table the running 52 week front end sales of 15 test stores are aggregated and averaged (in this embodiment $262,103,930 divided by 15). The average running 52 week front end sales of the test stores (in this embodiment $17,473,595) is divided by the similar average for all stores ($15,583,067 see Table 1-I) producing a Test Store bias index (in the present embodiment 1.12). While this value is not intrinsic to the analysis when compared to the subclass index it demonstrates the necessity of using a subclass index number.

The running 52 week front end Subclass sales of the 15 test stores (not shown) were similarly aggregated (in the present embodiment $39,394) and averaged producing a running 52 week front end Subclass sales average per store (in the present embodiment $2,626). This test stores Subclass sales average is divided by the similar average for all stores calculated in Table 1-I (in the present embodiment $1,289) which produces a Test Store Subclass Bias Index (in the present embodiment 2.04). It can be readily seen that the Test Store Subclass Bias Index is significantly larger than the Test Store Bias Index for all front end products. The Test Store Subclass Bias Index will be used in subsequent calculations.

Table 1-K projects the annual sales volume and gross margin of the test product using a variety of factors including Seasonality Index, bimonthly growth rate, test store volume Bias Index, In-Stock Index, and Advertising and Promotion Adjustment.

The base number in this table is Period 1 Test Product Sales. Period 1 corresponds to the 8 week test period. In the present embodiment this value is identified in Table 1-E for each of the two SKUs that together comprise the test product (in the present embodiment $391 and $182 respectively). The annual volume and margin projection process is similar for each SKU.

The base number is multiplied by the Advertising and Promotion adjustment factor to produce Period 1 Test Product Sales. In the present embodiment this adjustment factor is 1.00. An adjustment for advertising and promotion above 1.00 can mean that there was no advertising or promotion during the test period and there will be during the first year in distribution such that sales will increase by a certain percentage expressed as a decimal and added to 1.00. Alternatively an adjustment above 1.00 can mean the level of advertising or promotion presented in the marketing program by the vendor to the Category Manager exceeds the test period level adjusted for seasonality. It is well known by those engaged in retailing that seasonal spikes in volume are frequently related not only to seasonal demand patterns but also to advertising and promotional activity that is typical during such periods and would not therefore warrant an advertising or promotional adjustment factor above 1.00.

The seasonality index of Period 1 which corresponds to the test period is always assigned a value of 1 regardless of which months comprise that period. Period 2 is assigned a seasonality index number based upon the relationship between Subclass sales in all stores during that period and Subclass sales in all stores during Period 1 (in the present embodiment 0.72806172). Seasonality Index numbers are assigned similarly for periods 3 though 6.

A bimonthly growth rate is established for the test products by aggregating the bi-monthly volumes of the 5 most recently introduced new products. The aggregated volumes of the first and last bimonthly periods are adjusted for seasonality and a compound bi-monthly growth rate is calculated (not shown) that produces the last bi-monthly period volume.

The Period 2 Test Product Sales value is calculated by multiplying the Period 1 base number by the seasonality index and by 1 plus the bi-monthly growth rate (for SKU 1 in the present embodiment (391×0.72806172×1.08)).

The Period 3 Test Product Sales value is calculated by multiplying the Period 2 Test Product Sales (for SKU Iin the present embodiment 307) by the seasonality index and by 1 plus the bi-monthly growth rate (for SKU 1 in the present embodiment (307×0.63824218×1.08)).

Test Product Sales are Similarly Calculated for Periods 4,5 and 6.

Test Product Sales are aggregated for Periods 1 through 6, divided by 48 and multiplied by 52 which adjusts for a missing week in each of the four quarters of the year. There are 8 weeks in each bimonthly period. Eight weeks times six periods equals 48 weeks. There are 52 weeks in a calendar year. In the present invention the result of this calculation for SKU 1 is $1,764.

Aggregated test product sales that have been adjusted for advertising, promotion, seasonality and first year growth rate are divided by the number of test stores and multiplied by the number of stores in which distribution is authorized going forward (for SKU 1 in the present embodiment ($1,764/15×885=$104,047)) which produces an interim annual sales forecast.

The interim annual sales forecast is divided by the Test Store Subclass Volume Bias Index and multiplied by the In-stock Index which produces the annual sales forecast for the test product (for SKU 1 in the present embodiment (104,047/2.04×0.92=$46,923)).

The Test Store Subclass Volume Bias Index was calculated in Table 1-J. The In-stock Index is the in-stock percentage for all items in the Subclass during the prior fiscal year.

The annual sales forecast is multiplied by the percentage gross margin which produces the annual gross margin forecast (for SKU 1 in the present embodiment ($46,923×41.3%=$19,379)).

The annual forecast procedure for sales and margin is repeated for other SKUs comprising the test product (in the present embodiment SKU 2).

The annual sales and gross margin forecasts are aggregated for SKUs comprising the test product (in the present embodiment $106,406 and $41,433 respectively).

Table 1-L projects the annual peer group margin lift which is a critical value used to determine the change in contribution margin that results when a test product is substituted for an incumbent product in the test product's peer group.

The process for calculating margin lift is similar to the process for projecting a test product's annual sales. There are two key differences, the base number and the elimination of the gross margin calculation step which is unnecessary.

The base number used for calculating margin lift is the test period Peer Group Margin Lift that appears in Table 1-G (for SKU 1 in the present embodiment $338). The base number is first multiplied by the Advertising and Promotion adjustment factor to produce Period 1 Margin Lift. Subsequently Period 1 Margin Lift is multiplied by the seasonality index and the first year bi-monthly growth rate to produce Period 2 Margin Lift (for SKU 1 in the present embodiment $266). Seasonally and growth adjusted Margin Lift is calculated for all 6 periods and aggregated. This sum is divided by 48 and multiplied by 52 to produce the projected annual seasonally and growth adjusted margin lift for the test stores.

Projected annual test store margin lift is divided by the number of test stores and multiplied by the number of stores in which distribution will be authorized to produce interim annual adjusted margin lift. This value is divided by the Test Stores Volume Bias Index and multiplied by the In-Stock index to produce Annual Projected Margin Lift for the test product's peer Group in Year 1 (for SKU 1 in the present embodiment $49,926).

Annual Margin Lift for SKU 2 is calculated in the same manner as for SKU 1 (for SKU 2 in the present embodiment $68,983).

Table 1-M calculates the effect of marking down, selling off, and removing remaining inventory of the item or items to be replaced by the test product. It is well know by those engaged in retailing that when most new items are introduced an existing item is discontinued in order to provide shelf space for the new item.

With the exception of the section Shifted Sales Margin Loss in this table, the Markdown Calculation described below is typical of retailers and is not an innovation.

The Average Retail Price and Average Cost of products in the Bottom Quartile of the Peer Group were calculated in Table 1-B (and in the present embodiment are $4.79 and $2.50 respectively).

The average units sold per store per week per item are the average annual unit sales of the two items in the bottom quartile of the test item's peer group (not shown) divided by the total number of stores in the chain and divided by 52 weeks in a year (in the present embodiment 0.23).

The number of items is the number of items that will be replaced in order to make room for the 2 test product SKUs. In the present embodiment the number of items to be replaced is the same as the number of test SKUs (2).

The number of weeks is the number of weeks in which the items to be replaced will be sold at a marked down retail price. In the present embodiment the number of weeks is 4.

The average stores per item is the number of stores in which the items being marked down will be sold. In the present embodiment the number of stores is 885 which number of stores results from the acquisition of The Test Retailer's 2,242 stores by a consortium and the sale of a substantial number of The Test Retailer stores to entities other than The Acquiring Retailer which currently owns the largest block of The Test Retailer stores (885).

The unit lift is the percentage increase in sales expected to result from the markdown of items being replaced plus 100% (in the present embodiment 150%).

Markdown % is the percentage by which the retail price will be reduced or marked down (in the present embodiment 50%).

Vendor Support % is the percentage of the marked down cost of items being replaced that the current vendor will pay to the retailer. It is well known to those engaged in retailing that when a retailer reduces the retail price of an item by a certain percentage in order to stimulate sales the vendor is frequently required to refund to the retailer the cost of the marked down item times the percentage that the retail price is reduced times the number of units that are sold at the marked down price. When an item is being discontinued a vendor will typically pay only a fraction of the cost reduction described above (in the present embodiment 50%).

Total Pieces Moved Regular is the average number of units that would be sold at the regular retail price during a markdown period (in the present embodiment 4 weeks). The number of pieces moved in the period is the average number of units per store per week per peer group item times the number of items being replaced times the number of stores in which the discontinued item is being marked down times the number of markdown weeks (in the present embodiment (0.23×2×885×4=1,628)).

Total Pieces Moved markdown is the Total Pieces Moved Regular times the unit lift (in the present embodiment (1,628×150%=2,443).

Regular Sales are Total Pieces Moved times average retail price (in the present embodiment (1,628×4.79=$7,800)) [rounding].

Regular GM is the Regular Sales minus Average Cost times Total Pieces Moved (in the present embodiment ($7,800−(2.50×1,628)=$3,729) [rounding].

Markdown Sales are Total Pieces Moved Markdown times Average Retail times markdown Percentage (in the current embodiment (2,443×4.79×0.50=5,850).

Markdown Gross Margin Dollars are Markdown Sales minus Average Cost times Total Pieces Moved Markdown (in the present embodiment (5,850−(2.50×2,443)=−$256) [rounding].

Vendor Billing Dollars is Average Cost times Markdown percentage times Vendor Support percentage times Total Pieces Moved Markdown (in the present embodiment (2.50×50%×50%×2,443=$1,527).

Markdown Gross Margin Dollars plus Vendor Billings in the present invention is (−256+1,527=1,270).

Net Gross Margin Benefit is Markdown Gross Margin plus Vendor Billings minus Regular Gross Margin (in the present embodiment (1,270−3,729=−2,459).

Lift units are Total Pieces Moved markdown minus total Pieces Moved Regular (in the present embodiment (2,443−1,628=814).

Percentage cannibalized from The Test Retailer is the percentage of unit lift sales that would otherwise have been full price sales of other items in The Test Retailer Assortment (in the present embodiment 50%).

Average Margin is Average Retail minus Average Cost (in the present embodiment $2.29).

Margin Lost to Shifted sales is Lift units times Percent Cannibalized from the Test Retailer times Average margin (in the present embodiment (814×50%×2.29=$932)).

Table 1-N calculates the increase or decrease in contribution margin that results from replacing an existing item(s) with a test product. The calculation adjusts margin lift by changes to vendor funding, reclamation costs, and replacement costs.

Test Product seasonally adjusted annual sales and margin lift at authorized stores was calculated in Table 1-L. In the present embodiment they are $68,983 and $49,926 respectively

Seasonally adjusted annual sales and cost of the average peer group product at authorized stores were calculated in Table 1-D. In the present embodiment they are $67,113 and $35,027 respectively.

Vendor funds lift expressed either as a percentage of Test Product cost to the retailer or as a net dollar amount is provided by the Category Manager after negotiation with the vendor. In the present embodiment vendor funds lift is expressed as a percentage of Test Product cost lift to the retailer, specifically 8%.

Vendor Funds Lift is Test Sales Lift minus Test Margin Lift times the percentage of Test Product Cost (to the retailer) that is paid by the vendor as Vendor Funds. Alternatively it is the specific amount by which vendor funding for the test product varies from vendor funding for the product being replaced. In the present embodiment Vendor Funds Lift is (($68,983−49,926)×8%=$1,525).

Vendor funds in excess of or less than the percentage of vendor funding applied to Test Product Cost Lift (to the retailer) would be greater or less than zero if the percentage of vendor funding applied to the cost to the retailer of the item being replaced were different from the percentage of vendor funding applied to the cost of Test Product to the retailer. In such case the difference in percentage would be applied to the Cost Lift to the retailer. In the present embodiment Vendor funding for the test product and the product being replaced is 8% of cost to the retailer. Therefore there is no adjustment to Vendor Funds Lift and the value is zero.

The Increase or Decrease in Vendor Funds from the test product is the Vendor Funds Lift minus an increase or decrease in vendor funding as described above. In the present embodiment the Increase in Vendor Funds is ($1,525−0=$1,525).

Pre-Markdown Inventory dollars per replaced item were calculated in Table 1-D. In the present embodiment inventory dollars are $7,018.

Number of replaced items is the number of items required to be replaced in order to provide shelf space for the test product. In the present embodiment the number of products required to be replaced is 2.

Pre-markdown inventory dollars are inventory dollars per replaced item times the number of items being replaced. In the present embodiment Pre-markdown inventory dollars are ($7,018×2=$14,036).

Average cost per replaced item was calculated in Table 1-B as the average cost of a Bottom Quartile item. In the present embodiment the average cost per replaced item is $2.50.

Pre-markdown inventory units is Pre-markdown inventory dollars divided by the average cost per replaced item. In the present embodiment Pre-markdown inventory units are ($14,036/2.50=$5,614).

Markdown lift units were calculated in Table 1-M. In the present embodiment markdown Lift units are 814.

Post Markdown Inventory is Pre-Markdown inventory minus Markdown Lift units. In the present embodiment Post Markdown inventory is (5,614−814=4,800 units).

Post markdown inventory value is Post-markdown inventory units times Average cost per replaced item. In the present embodiment the Markdown inventory value is (4,800×$2.50=$12,001).

Transportation, storage and handling expense @ 10% of post-markdown inventory value. It is well known to those engaged in retailing that discontinued products are sometimes shipped to a returns center and disposed of by selling to a salvage company at a deep discount. In other cases the inventory is either disposed of locally, sometimes to a charitable institution, or is allowed to be sold until the inventory is depleted. In the present embodiment the items being replaced were to be disposed of locally. Therefore the value assigned to transportation, storage and handling of remaining inventory is zero.

Reclamation costs are Post-markdown inventory value minus transportation, storage and handling expenses if any. In the present embodiment Reclamation costs are ($12,001−0=$12,001).

Cost to Retailer A to cut in one new product per store is calculated with an hourly rate charged by a third party merchandising company. This function is known as detailing. It comprises removing product to be displaced and rearranging product assortment on the shelf following a plan-o-gram typically created for stores by the retailer's visual merchandising department. The test product that is being introduced comprises in part the new plan-o-gram. The amount of time devoted to cutting in new product varies with the number of changes required by the new plan-o-gram. In the present embodiment the cost to cut in the new product in one store is (1 hour×$22/hr=$22).

Number of authorized stores. The number of stores in which a new product is sold is usually the number of stores of the retailer. In the case where a retailer has acquired other retailers (called banners) it is possible that a product is not authorized in all banners particularly where store formats vary as by way of example convenience stores and superstores. Geography is another reason for limiting distribution. In the present embodiment the number of authorized stores is 885.

Cost to cut in products in authorized stores is the cost to cut a new product into one store times the number of stores in which distribution is authorized. In the present embodiment the cost to cut in products in authorized stores is ($22×885 stores=$19,470)

Vendor contribution to cut in products is the amount of money that the vendor pays to the retailer to offset the cost of cutting in a new product. Depending on the retailer this cost can vary from zero to the entire cut-in cost. In the present embodiment the Vendor contribution to cut in products is 100% of the actual cost ($19,470×100%=$19,470).

Net cost to cut in product is the Cost to cut in products in authorized stores minus Vendor contribution to cut in product(s). In the current embodiment the net cost to cut in product is ($19,470−19,470=0).

Margin Lift from adding a new product was calculated in Table 1-L. In the present embodiment margin Lift from adding new products is $49,926.

Increase (Decrease) in vendor funds from Test Products vs. Bottom Quartile products was calculated above in this table. The value is $1,525.

There are four deduction from the above amounts: cut-in cost, net markdown Gross margin dollar cost, margin lost to cannibalized sales due to markdown, and reclamation costs. All are calculated above. In the present embodiment these costs are zero (in this table), $2,459 (Table 1-M), $932 (Table 1-M), and $12,001 (in this table) respectively.

In the present embodiment the increase (decrease) in gross margin and vendor funds less replacement cost resulting from replacement of two bottom quartile peer group products by the test product is ($49,926+1,525,−0−2,459−932−12,001=$36,059). This amount is the increase to the Test Retailer's contribution margin that results from replacing two products from the Bottom Quartile of the Saline Spray Peer Group with the two test SKUs.

What is claimed is:

1. A system and method for determining the effect on a retailer's first year contribution margin that results from replacing an incumbent peer group product by a test product, the system and method comprising: means for collecting and storing data of past sales, means for normalizing test product and peer group sales that uses a mathematical model to index sales data and seasonality, means for forecasting peer group margin lift based upon test store and normalized control store test period sales, means for forecasting annual test product sales based upon normalized test store sales, means for determining the effect of first year build-rate and advertising and promotion and in-stock levels on test product sales forecasts, means for determining the effect of markdowns and incumbent product disposition on contribution margin, means for determining the net cost of shelf work, means for determining the net effect of vendor funding, means for accepting user input of five or more variables, and means for calculating first year contribution margin based upon normalized margin lift.

2. The system and method of claim 1 wherein the means for collecting and storing data of past sales is a retailer's in-house software program, Catalyst Data 4.0.

3. The system and method of claim 1 wherein the means for collecting and storing data of past sales is a software program, Micro Strategy.

4. The system and method of claim 1 wherein selected stored data is converted into Microsoft Excel format.

5. The system and method of claim 1 wherein the software program that performs mathematical operations on the stored data and other inputs is Microsoft Excel.

6. The system and method of claim 1 further comprising means for collecting and storing data of past sales whereby past sales are classified by subcategory.

7. The system and method of claim 1 wherein seasonality index values for bi-monthly periods are determining by comparing subcategory bimonthly period sales to subcategory sales in a bimonthly test period.

8. The system and method of claim 1 wherein sales data of control stores is indexed to sales data of test stores using a ratio calculated by comparing the annual subcategory sales of control stores to annual subcategory sales of test stores.

9. The system and method of claim 1 wherein the sales data of test stores is indexed to all stores using a ratio that is calculated by comparing annual subcategory sales of test stores to annual subcategory sales of all stores.

10. The system and method of claim 1 wherein the peer group is a subset of subcategory products determined by the presence of a limiting characteristic not present among all subcategory members but present in the test product.

11. The system and method of claim 1 wherein first year build-rate for a test product is a smoothed percentage determined by comparing the average monthly sales of the five most recently introduced products in the test product's category that have been in distribution more than one year.

12. The system and method of claim 1 wherein the means for determining advertising and promotional effect is a factor determined by the Category Manager, based upon a program provided by the test product vendor.

13. The system and method of claim 1 further comprising a means for determining gross margin of peer group products in test and control stores.

14. The system and method of claim 13 wherein the means for determining gross margin of peer group items is the extension of peer group sales by a gross margin percentage calculated by subtracting each peer group product's cost recorded in the sku setup file from each peer group product's selling price recorded in the sku setup file and dividing by the selling price.

15. The system and method of claim 1 further comprising means for calculating gross margin lift whereby gross margin lift is a value determined by subtracting the indexed control stores' aggregate gross margin in the test period from the test stores' aggregate gross margin in the test period.

16. The system and method of claim 1 wherein test period gross margin lift is the base value used to calculate test product annual gross margin lift from which the annual contribution margin effect can be determined.

17. The system and method of claim 1 further comprising means for calculating markdown gross margin dollars.

18. The system and method of claim 17 wherein net markdown gross margin dollars are calculated by subtracting from regular gross margin dollars in a comparable time frame the sum of vendor billing plus the product of average units sold per store per week of the average of peer group items times the number of weeks of the markdown period times one plus the markdown lift expressed as a percentage times the difference between the average cost and average selling price of peer group items.

19. The system and method of claim 18 wherein vendor billing is the product of the average cost of subgroup items times the markdown percentage times the vendor support percentage times total markdown units sold.

20. The system and method of claim 17 wherein margin lost to markdown cannibalization comprises the product of markdown lift units times the percentage cannibalized from the test retailer times margin dollars per unit.

21. The system and method of claim 1 wherein the means for determining the net cost of shelf work for a new product comprises the hourly rate of detailer's labor times the time in hours to cut in the test product times the number of stores in which distribution is authorized minus the vendor contribution to shelf work expense.

22. The system and method of claim 1 wherein the means for accepting user inputs is a factor based on past experience within the category for each input determined by the Category Manager and such inputs comprise the effects of advertising, promotion, in-stock level, and number of stores in which distribution is authorized.

23. The system and method of claim 1 wherein the means for calculating net first year contribution margin effect comprises adding to forecasted normalized peer group annual margin lift the amount of net vendor funding for the test product, and subtracting the sum of reclamation costs, net markdown cost, net shelf work cost, and markdown induced cannibalized sales.

24. An article of manufacture for calculating the first year net contribution margin effect of substituting a test product for an incumbent item in the test product's peer group comprising: computer means, software means, means for collecting and storing data of past sales, means for normalizing test product and peer group sales that uses a mathematical model to index sales data and seasonality, means for forecasting peer group margin lift based upon normalized control store test period sales, means for forecasting annual test product sales based upon normalized test store sales, means for determining the effect of first year build-rate and advertising and promotion and in-stock levels on test product sales forecasts, means for determining the effect of markdowns and incumbent product disposition on contribution margin, means for determining the net cost of shelf work, means for determining the net effect of vendor funding, means for accepting user input of five or more variables, and means for calculating first year contribution margin based upon normalized margin lift.
